(19) United States
(12) Patent Application Publication
(10) Pub. No.: US 2011/0084127 A1
(43) Pub. Date: Apr. 14, 2011

(54) Voice Code for Distribution Centers

(76) Inventor: Elliott Grant, Redwood City, CA (US)

(21) Appl. No.: 12/576,092

(22) Filed: Oct. 8, 2009

(51) Int. Cl. G06F 17/00; G06K 19/06; G06K 19/00

(52) U.S. Cl. 235/375; 235/494; 235/454

(57) ABSTRACT

A Produce Traceability Initiative compliant case label includes the GTIN, the lot code, and a short numeric voice code. The voice code is derived from the GTIN and the lot code by an algorithm. Cases of goods that include these case labels are shipped by the source of goods to a distribution center for redistribution to retailers. The distribution center records the GTIN and lot code upon receipt. The distribution center uses the same algorithm to generate voice codes, and then uses the voice codes to direct pickers to fill orders from specific lots using automated pick systems. Pickers use the voice codes to find the intended cases and to confirm that cases from the intended lot were picked, or to indicate a different lot was picked. The distribution center then associates the lot code of the picked lot with the outgoing order.

### BACKGROUND OF THE INVENTION

1. Field of the Invention

The invention relates generally to the field of product traceability and more particularly to tracking cases through distribution centers.

2. Description of the Prior Art

The Produce Traceability Initiative (PTI) is an initiative designed to improve traceability of produce through the entire supply chain from the source to the point of sale. Compliance with the Initiative requires that each case of goods carry a label that includes a Global Trade Identification Number (GTIN) and a lot code. Further, the GTIN and lot code for each case are recorded at each point along the supply chain.

FIG. 1 illustrates a typical supply chain. Each source of goods 100, such as a produce grower, sends pallets 110 of goods to a distribution center 120. Each pallet 110 includes a plurality of cases 130, each case 130 bearing a label (not shown) with the requisite GTIN and lot code. While the Initiative is an undertaking of the produce industry, it can be seen that sources of goods 100 can just as easily be meat packers, dairies, canners, processed food manufacturers, pharmaceutical makers, and so forth.

To comply with the Initiative, each source of goods 100 records the GTIN and lot code in a database 140 for each case 130 that is shipped. The GTIN and lot codes on a pallet may also be summarized on a pallet label which shows the GTIN and lot code and quantity of cases on that pallet.

At the distribution center 120 the GTINs and lot codes of the received cases 130 are again recorded, this time in a database 150. The distribution center 120 can either scan every case label with a bar code scanner or scan the pallet label with the summary barcode or use some other electronic means to load the GTIN and lot codes and quantities into their database 150. Next, the pallets 110 are typically moved into a warehouse location awaiting outbound shipping to individual retailer stores or restaurants 160. To fulfill orders, new pallets 170 are assembled with cases 130 from different sources of goods 100. Here, compliance with the Initiative becomes much more burdensome on the distribution centers 120.

A typical distribution center 120 employs a Warehouse Management System (WMS). The WMS tracks the location of each pallet 110 and the number of cases 130 remaining on each. When a retailer 160 submits an order, a picker is directed by the WMS to various locations within the distribution center 120 with instructions for the number of cases to be picked at each. In this way the picker assembles the pallet 170. An exemplary command would be “Station 18, six cases.” In the typical distribution center 120 the picker receives spoken commands from the WMS through a wireless headset and speaks into the headset to communicate confirmation back to the WMS.

Picking orders for retailers 160 in this manner is highly efficient, however, attempts to add a step to the picking process for recording GTINs and lot codes of cases 130 as they are picked have proved to be problematic. When pickers have to manually scan every case 130 with a barcode scanner it significantly increases the time it takes to fill orders. In the alternative, pickers can read to the WMS at least a part of the lot code on each picked case. This has not proven to be satisfactory, either. For instance, if the practice is to read the last three characters of each lot code, sometimes two lots on the same pallet 130 will have different lot codes that coincidentally end in the same last three characters and the WMS cannot determine which lot code to associate with the order. Additionally, voice recognition systems tend to have trouble differentiating spoken letters, leading to further sources of error as lot codes can include any alphanumeric character. Moreover, pickers may misread codes or read the GTIN instead of the lot code.

For the lack of a simple workable solution that does not hurt productivity, distribution centers 120 have been reluctant to committing to implementing the Initiative to the extent of recording GTIN and lot code of cases 130 being distributed to retailers 160. It can be seen, therefore, that there is a need for an efficient way to record the GTIN and lot code of cases 130 being assembled onto pallets 170 for distribution to retailers 160.

### SUMMARY

The present invention provides a case label that can be affixed to cases by a source of goods. Exemplary case labels comprise a GTIN and lot code both in a machine-readable format and in a human-readable format. Exemplary case labels also comprise a numeric code, also referred to herein as a voice code, of no more than three digits. The voice code on each case label is generated from the specific GTIN and lot code on that case label. In various embodiments, the voice code is made more prominent than other codes, for example, by being printed with a larger font size and/or as white numerals on a black background on the case label.

The present invention also provides methods for labeling cases at a source of goods. One such exemplary method comprises using an algorithm to generate a voice code of three or less digits from a GTIN and lot code. The exemplary method can also comprise printing a case label after generating the voice code, where the case label includes each of the GTIN, lot code, and voice code. In various embodiments, generating the voice code comprises hashing the GTIN and lot code and constraining the output with a modulo function. The exemplary method can also comprise affixing the case label to a case, and recording the GTIN and lot code in a database when the case is shipped.

The present invention further provides methods for utilizing voice codes on case labels in distribution centers to implement efficient tracking of outgoing cases. An exemplary method comprises receiving a pallet of cases, each case having a case label including a GTIN, lot code, and voice code. The method can further comprise reading the GTIN and lot code from a case label, for example with a barcode scanner, and recording the GTIN and lot code in a WMS.

The method can further comprise receiving a pick order for a number of cases of the GTIN and selecting a particular lot code for that GTIN from which to fill the order. The method additionally comprises generating a voice code from the GTIN and the selected lot code. The voice code is generated using the same algorithm used to generate the voice code printed on the labels of the cases of the selected lot code. The method can further comprise directing a picker to fill the order, for example, by providing the picker with a location in the distribution center, the number of cases, and the voice code. The picker fills the order with the number of cases having the voice code thereon, and confirms the voice code back to the WMS. The method can further comprise the WMS receiving the confirmation and creating a record in a database of an association between the order and the number of cases of the GTIN and lot code.

### BRIEF DESCRIPTION OF DRAWINGS

FIG. 1 is a schematic representation of a supply chain of the prior a

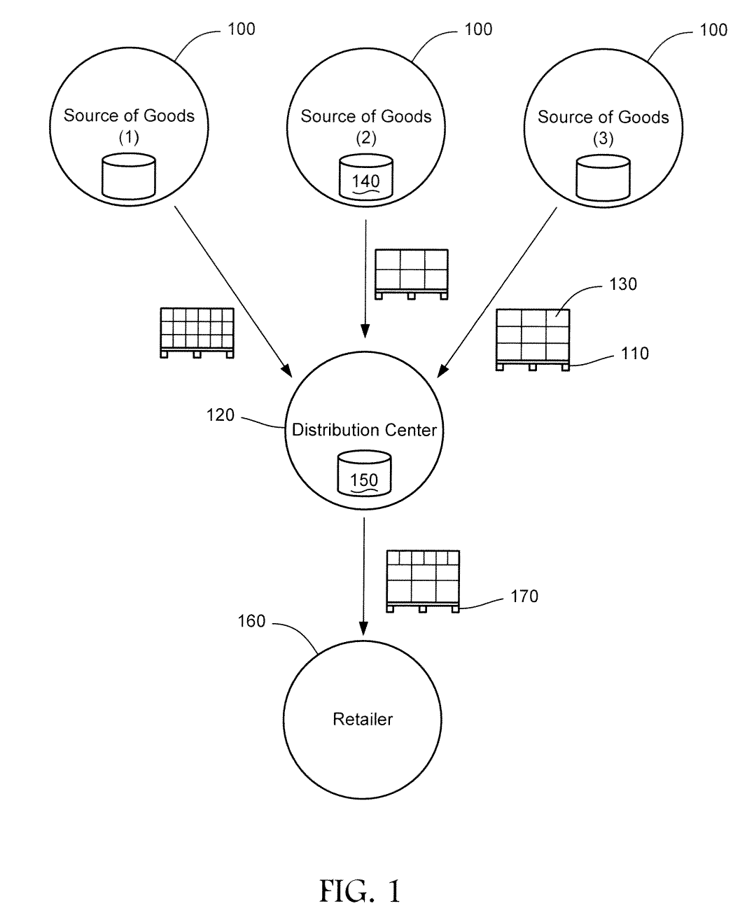

FIG. 2 illustrates a case including a case label according to an exemplary embodiment of the invention.

FIG. 3 is a flowchart representation of a method according to an exemplary embodiment of the invention.

FIG. 4 is a flowchart representation of a method according to another exemplary embodiment of the invention.

### DETAILED DESCRIPTION OF THE INVENTION

The present invention provides labels that comply with the PTI and that also include a prominent voice code of one, two, or three digits. The voice code is generated at the source of goods 100 from the GTIN and lot code according to a particular algorithm that is shared with the distribution center 120. When a pallet 110 of cases 130 is received by the distribution center 120, a representative case label (or case labels, if the pallet 110 includes cases 130 from more than one lot) is read to create a record of the received GTIN and lot code combination. The voice code is again generated according to the algorithm, this time by the distribution center 120, using the shared algorithm. When an order for a GTIN is received from a retailer 160, a picker receives an instruction from the WMS to pick cases of the GTIN having the specific voice code. The picker can confirm the voice code to the WMS. It will be appreciated, therefore, that the picker does not have to employ a barcode reader, nor read a string of alphanumeric characters into a headset. It will be further appreciated that the present invention does not require the use of additional labeling of received pallets 110 by the distribution center 120.

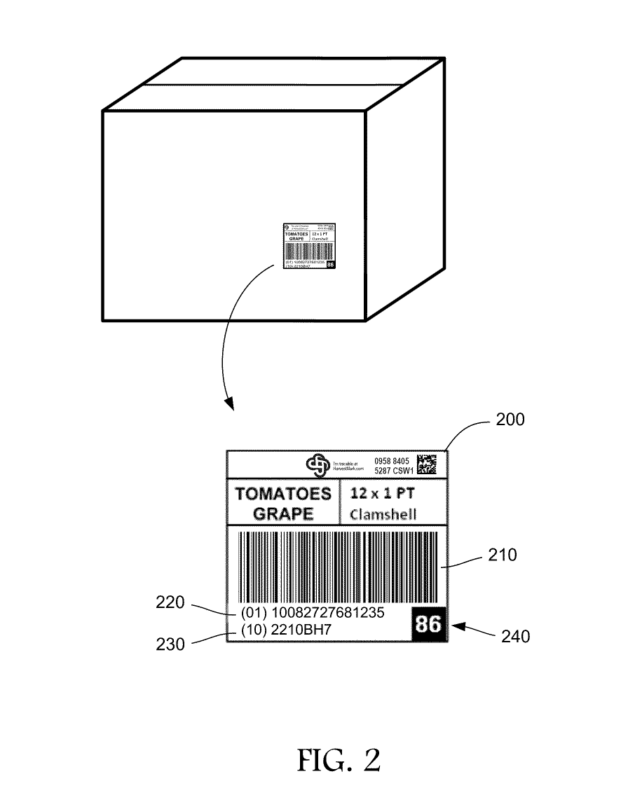

FIG. 2 provides a case 130 including an exemplary case label 200 of the present invention. The case label 200 complies with the PTI in that case label 200 includes a GTIN and a lot code in both a machine-readable format (the barcode 210) and a human-readable form a (GTIN 220 and lot code 230, respectively). The GTIN is a 14 digit numeric code while the lot code can be up to 20 alphanumeric characters. It will be understood that case label 200 is merely exemplary and labels for other containers commonly used to transport goods, such as trays, crates, sacks, RPCs, and bins, can also be made with a general code such as GTIN, a specific code such as the lot code, and a voice code generated from the other two codes.

The GTIN represents information about the contents of the case that is independent of the particular lot such as the brand name, type of product (e.g., grape tomatoes), quantity per unit, and so forth. The lot code, on the other hand, is associated with lot-specific information such as harvest event data like harvest date, harvest location, packing crew, and so forth. GTIN and lot codes are discussed in greater detail in U.S. patent application Ser. No. 12/176,334 filed on Jul. 19, 2008 and entitled “Case-Level Traceability Without the Need for Inline Printing,” U.S. patent application Ser. No. 12/414,123 filed on Mar. 30, 2009 and entitled “Parent Case Labels with Multiple Child Labels for Field Packed Produce,” and U.S. patent application Ser. No. 12/471,201 filed on May 22, 2009 and entitled “Case Labeling for Field-Packed Produce,” each of which is incorporated herein by reference.

The case label 200 optionally also includes one or more fields to identify the contents of the case 130. The case label 200 also optionally includes a unique serial number to uniquely identify the case 130 for further traceability purposes. In the FIG. 2 the unique serial number comprises 16 alphanumeric characters in both a human-readable format and a machine-readable format in the upper right corner of the case label 200. Such unique codes are discussed in greater detail in U.S. patent application Ser. No. 12/206,156 filed on Sep. 8, 2008 and entitled “Attributing Harvest Information with Unique Identifiers,” U.S. patent application Ser. No. 11/619,747 filed on Jan. 4, 2007 and entitled “System and Method of Code Generation and Authentication,” and U.S. patent application Ser. No. 11/347,424 filed on Feb. 2, 2006 and entitled “Method and System for Deterring Product Counterfeiting, Diversion and Piracy,” each of which is incorporated herein by reference.

The case label 200 further comprises a voice code 240. The voice code 240 is a numeric code of three or less digits derived from the GTIN and lot code by an algorithm. It is noted that the voice code 240 is not alphanumeric, but simply numeric, so as to exclude letters that are more likely to be misinterpreted by automated voice-recognition systems. While the voice code 240 can be three or less digits, two digits strikes a balance between ease of use (fewer digits for a picker to receive and repeat) and the total number of useful permutations. The voice code 240 is preferably printed in such a way as to make the voice code 240 stand out prominently on the case label 200, for example, by using a larger font size and/or white characters on a black background, as shown in FIG. 2.

The voice code 240 is generated from the GTIN and lot code with an algorithm at or before the time of printing. For example, the GTIN and lot code can be hashed with a hash function, such as MD5, with the output constrained to the desired domain (e.g., 2 digits) using a modulo function. Other exemplary implementations use a simple CRC (cyclic redundancy check), or another polynomial, to hash the GTIN and lot code, again with the output constrained to the desired domain using a modulo function. Still another exemplary implementation uses a modified Luhn/Regenstrief Institute algorithm to hash the GTIN and lot code. In some embodiments, the algorithm is configured to not produce certain values for the voice code 240, such as where both digits are the same, or where the first digit is zero.

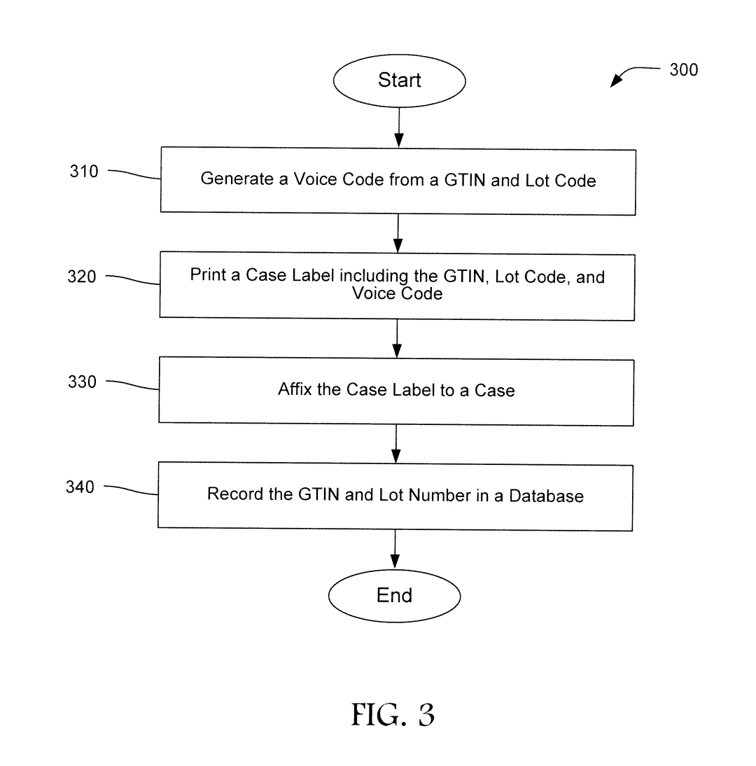

FIG. 3 illustrates an exemplary method 300 of the invention. The method 300 can be performed, for example, at a source of goods 100. The method 300 comprises a step 310 of generating a voice code 240 from a GTIN and lot code. As noted above, an algorithm is used to derive the voice code 240. In a step 320 a case label 200 is printed. The case label 200 includes the GTIN, lot code, and voice code 240. The case label 200 is then affixed to a case 130 in a step 330, for example, with an adhesive backing.

In a step 340 the GTIN and lot code are recorded in a database 140. Step 340 can also comprise recording other information in association with the GTIN and lot code such as the shipping time and date, a pallet identification, the intended destination, and so forth. The GTIN and lot code can be associated together and recorded at the time the voice code is generated, or at the time the case label 200 is printed, for example. Further information can be recorded in the database 140 in association with the GTIN and lot code as such information becomes available. In some embodiments, recording the additional information in association with the GTIN and lot code includes reading the GTIN and lot code with a barcode scanner from a case label 200 on a case 130 on a pallet 110.

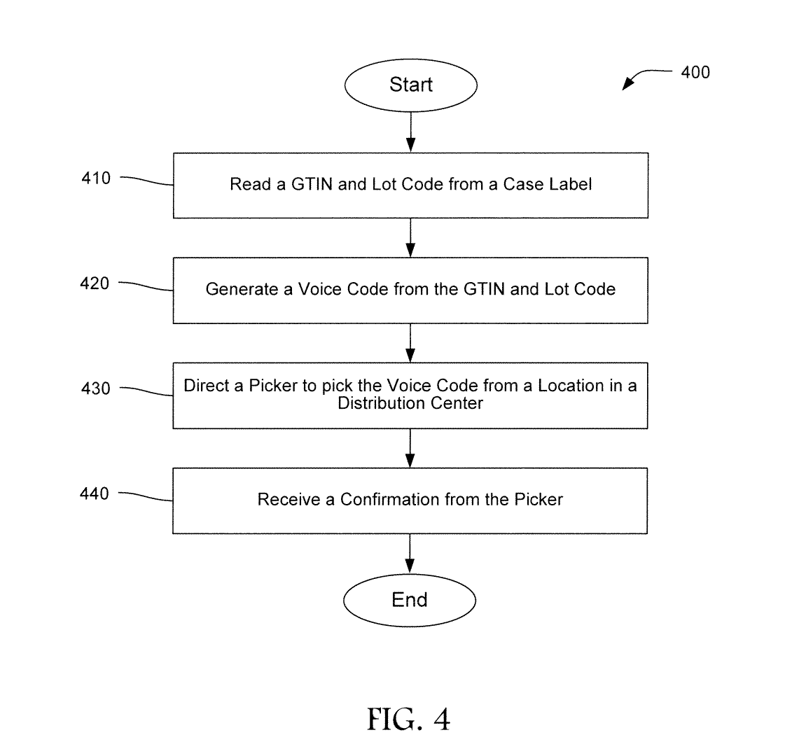

FIG. 4 illustrates another exemplary method 400 of the invention. The method 400 can be performed, for example, at a distribution center 120. The method 400 comprises a step 410 of reading a GTIN and lot code from a case label 200, for example, with a barcode scanner. The GTIN and lot code can be recorded in a database 150 and associated in the database 150 with other information such as the time and date of receipt.

In a step 420 the same algorithm used in step 310 of method 300 is used to generate the voice code 240 from the GTIN and lot code. Step 420 is performed, in some embodiments, by a WMS. Optionally, the voice code 240 is stored in association with the GTIN and lot code in the database 150 for later use, while in other embodiments the voice code 240 is generated upon receipt of an order for the particular GTIN.

When an order for a number of cases 130 of a GTIN is received by the distribution center 120 from a retailer 160, and the order calls for less than a full pallet 110 of cases 130, the WMS identifies a pallet 110 of cases 130 from which to pick the number of cases 130 to fill the order. In a step 430 a picker is directed to a location in the distribution center 120 where the identified pallet of cases 130 having the required GTIN resides. Further, in step 430 the picker is directed to pick a case with a particular voice code from that location.

More specifically, the WMS maintains records of the number of cases 130 for each particular GTIN, and also of the number of cases 130 associated with each different lot code associated with each GTIN. The WMS determines which lot code, if more than one exists, that the picker should pick from in order to fill the order, for example, to move oldest inventory first. In step 430 the WMS can either read the voice code 240 from the database 150 if the voice code has been previously generated in step 420, else the WMS can perform step 420 in response to receiving the order. The WMS then provides the picker with the location, voice code, and number of cases, for instance, through a headset. The WMS can additionally record in the database 150 the GTIN, lot code, and number of cases associated with the order. Additional information can also be recorded such as the picker identification, time that the order was filled, and so forth.

In an optional step 440 the WMS receives a confirmation from the picker. For example, the picker can repeat the voice code and/or number of cases 130 back to the WMS using the headset.

It will be appreciated that the method 400 can lead to situations where more than one lot code will have the same voice code 240. For instance, by coincidence two lot codes hashed with the same GTIN will result in the same voice code 240. In some situations, one pallet 110 will be split such that some cases 130 are from a first lot code while some cases 130 are from a second lot code, and case labels 200 for both lots have the same voice code 240. It will be appreciated, however, that in many instances pallets 110 are homogeneous and all cases 130 have the same lot code and voice code 240. In those remaining instances where a pallet 110 is split between two or more lots, for a two digit voice code 240, there is only a small chance of a collision where the voice code 240 is not sufficient to differentiate the different lots.

The WMS can identify such potential collisions since the WMS has a record of all of the lot codes associated with each GTIN. In the event that a picker would be directed to a voice code 240 in a collision situation, the WMS can inform the picker to select cases 130 using an additional differentiator, such as the first or last character of the lot code.

Another situation that can arise when a pallet 110 is split between two lots is the situation where the picker is directed to select cases 130 with a particular voice code 240, and those cases 130 are found to be buried on the pallet 110 beneath cases 130 from the other lot. Here, the picker can pick the number of cases 130 from the accessible lot and inform the WMS of the voice code of the picked cases 130 via the headset. The WMS can then associate the correct lot code with the order and deplete inventory accordingly.

Some steps of the methods described herein can be performed, for example, through the use of hardware, such as application-specific integrated circuits (ASICs), specifically designed to perform the particular functions of the method. Various steps of the methods described herein can also be performed through the use of firmware residing, for instance, in read only memory (ROM) or flash memory, where the firmware is programmed to perform the particular functions of the method steps. Steps of the methods described herein can also be performed by a processor capable of executing software residing in a memory, for example, in random access memory (RAM), where the computer instructions embodied in the software define the method steps. Any combination of two or more of hardware, firmware, and software can also be employed. Hardware, firmware, and/or software for implementing method steps may be embodied in handheld scanners, for example. Hardware, firmware, and/or software for implementing method steps may also be embodied in various types of computing systems such as servers and personal computers. It will be appreciated that such computing systems, when configured to follow specific logic embodied in their circuits or programming instructions, or both, constitute specific machines.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A label comprising:
a GTIN and lot code both in a machine-readable format and in a human-readable format; and
a numeric code of no more than three digits generated from the GTIN and lot code.

2. The label of claim 1 wherein the numeric code comprises two digits.

3. The label of claim 1 wherein the numeric code is printed as white numerals on a black background.

4. A method comprising;
generating a numeric code of three or less digits from a GTIN and lot code using an algorithm;
affixing a label to a case, the label including the GTIN, lot code, and numeric code; and
recording the GTIN and lot code into a database.

5. The method of claim 4 wherein generating the numeric code using the algorithm comprises hashing the GTIN and lot code and constraining the output with a modulo function.

6. The method of claim 4 further comprising printing the label after generating the numeric code.

7. A method comprising:
reading a GTIN and lot code from a label;
generating a numeric code of three or less digits from the GTIN and lot code using an algorithm;
directing a picker to pick the numeric code from a location in a distribution center;
receiving a confirmation from the picker; and
associating the GTIN and lot code with an order.

8. The method of claim 7 wherein the confirmation comprises the numeric code.

9. The method of claim 7 wherein reading the GTIN, and lot code from the label is performed with a barcode scanner.
